(19) United States
(12) Patent Application Publication
(10) Pub. No.: US 2014/0245160 A1
(43) Pub. Date: Aug. 28, 2014

(54) MOBILE APPLICATION FOR MONITORING AND CONTROLLING DEVICES

(71) Applicant: Ubiquiti Networks, Inc., San Jose, CA (US)

(72) Inventors: Jonathan G. Bauer, Los Angeles, CA (US); Christopher McConachie, Hermosa Beach, CA (US); Randall W. Frei, San Jose, CA (US)

(21) Appl. No.: 14/187,105

(22) Filed: Feb. 21, 2014

Related U.S. Application Data
(60) Provisional application No. 61/768,348, filed on Feb. 22, 2013.

(51) Int. Cl. H04L 12/24

(52) U.S. Cl. CPC H04L 41/22
USPC 715/736

(57) ABSTRACT

A sensor-monitoring application can execute on a mobile device, tablet computer, or other portable device, and facilitates controlling sensors and navigating through sensor data either directly or via a sensor-managing service. A user can monitor feedback from a variety of sensors, such as a motion sensor, a temperature sensor, a door sensor, an electrical sensor. The user may interact with the application's user interface to control and synchronize various sensors, controllers, power switches wirelessly. The user can also control devices, such as by sending a command to a device via an electronic port, or by enabling, disabling, or adjusting a power output from a power outlet that provides power to a device (e.g., to a light fixture).

### RELATED APPLICATION

This application claims the benefit of U.S. Provisional Application No. 61/768,348, Attorney Docket Number UBNT12-1017PSP, entitled “MOBILE APPLICATION FOR MONITORING AND CONTROLLING DEVICES,” by inventors Jonathan Bauer, Christopher McConachie, and Randall W. Frei, filed 22 Feb. 2013.

### BACKGROUND

1. Field

This disclosure is generally related to monitoring and controlling sensors and devices. More specifically, this disclosure is related to a user interface for a mobile or portable device that monitors and controls devices.

2. Related Art

Typical home automation technologies are often implemented using specially designed control and monitor devices that communicate with one another using a dedicated communication protocol. Because this communication protocol between devices is proprietary, home owners are having trouble to customize the system to include new or different monitor devices from other vendors. For example, in a home surveillance system, the surveillance system controller is oftentimes connected to various specially designed sensors and/or cameras that are manufactured by the same vendor. Moreover, to implement the centralized control, the appliances (or at least the controllers for each appliance) also need to be manufactured by the same vendor. If the homeowner also desires to install an automated sprinkler system, the homeowner may need to purchase and install a controller manufactured by a different vendor than the survaillance system.

To make matters worse, if a user desires to control the automation systems via a computer, the user may need to interact with a different user interface for each different automated system. If a homeowner desires to monitor the appliances of the survaillance system, the homeowner may need to utilize software provided by the same vendor as these appliances. Then, if the user desires to control the sprinkler system, the user may need to utilize a different application provided by the same manufacturer as the controller for the automated sprinkler system.

### BRIEF DESCRIPTION OF THE FIGURES

FIG. 1 illustrates exemplary operations for creating an interactive “space” for controlling one or more devices in accordance with an embodiment.

FIG. 2 illustrates exemplary operations for controlling devices via speech in accordance with an embodiment.

FIG. 3 illustrates exemplary operations for controlling devices via speech and/or a mobile application in accordance with an embodiment.

FIG. 4 illustrates a login prompt for accessing a mobile application for controlling an interfacing device in accordance with an embodiment.

FIG. 5 illustrates a display for presenting a terms-of-service statement 502 to a user in accordance with an embodiment.

FIG. 6 a display for presenting a privacy policy statement to a user in accordance with an embodiment.

FIG. 7 a login prompt and an on-screen keyboard for accessing a mobile application for controlling an interfacing device in accordance with an embodiment.

FIG. 8 illustrates an exemplary “Main View” user interface for monitoring and controlling devices in accordance with an embodiment.

FIG. 9 illustrates an exemplary space-selecting menu for selecting a space to monitor or control in accordance with an embodiment.

FIG. 10 illustrates an exemplary side panel for configuring the presentation of devices in accordance with an embodiment.

FIG. 11 illustrates an exemplary alerts menu for viewing recent alerts in accordance with an embodiment.

FIG. 12 illustrates an exemplary settings menu for configuring settings in accordance with an embodiment.

FIG. 13A illustrates an exemplary animation for displaying a sensor-detail view in accordance with an embodiment.

FIG. 13B illustrates an exemplary sensor-detail view for a power outlet in accordance with an embodiment.

FIG. 14 illustrates an exemplary sensor-detail view for a motion sensor in accordance with an embodiment.

FIG. 15 illustrates an exemplary sensor-detail view for a temperature sensor in accordance with an embodiment.

FIG. 16 illustrates an exemplary full-screen space view for a sensor deployment space in accordance with an embodiment.

FIG. 17 illustrates an exemplary user interface for placing, moving, and removing sensor icons over a sensor deployment space in accordance with an embodiment.

FIG. 18 illustrates an exemplary computer system that facilitates monitoring and controlling sensors and devices in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The mobile application facilitates controlling sensors and navigating through sensor data. A user can monitor feedback from a variety of sensors, such as a motion sensor, a temperature sensor, a door sensor, an electrical sensor (e.g., a current sensor, voltage sensor, power sensor, etc.). The user can also control devices, such as by sending a command to a device via a serial port, or by enabling, disabling, or adjusting a power output from a power outlet that provides power to a device (e.g., to a light fixture).

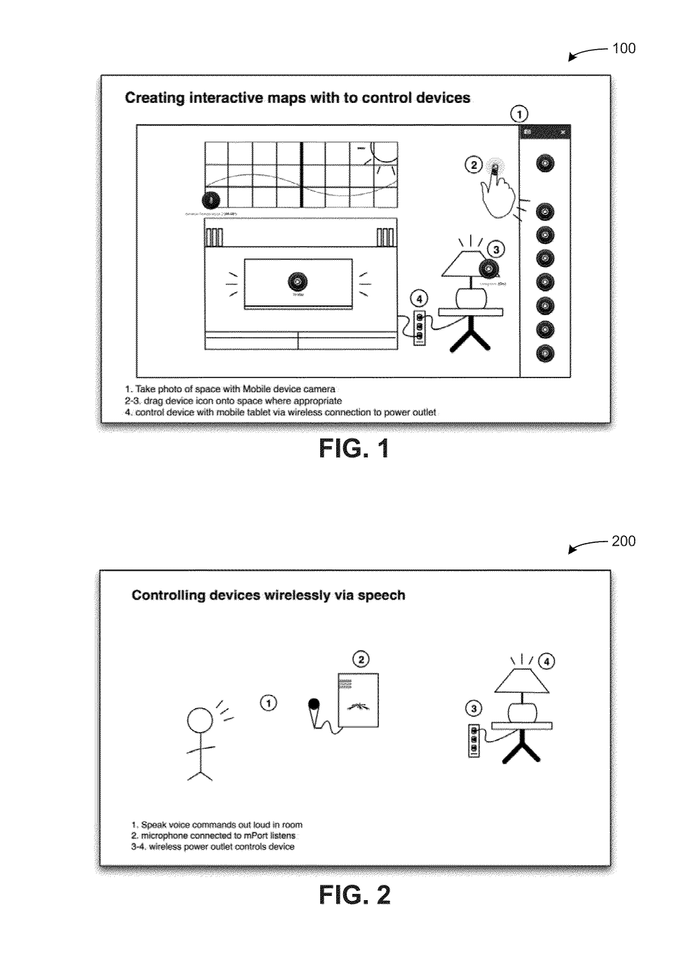

FIG. 1 illustrates exemplary operations for creating an interactive “space” for controlling one or more devices in accordance with an embodiment. During operation, a user can use a mobile application to create the interactive space, and/or to interact with the interactive space to control one or more devices. The mobile application can include a software application being executed by a device comprising a touch-screen interface, such as a smartphone, a tablet computer, or a laptop. The touch-screen interface can include a capacitive-touch interface, a resistive-touch interface, or any other touch-screen interface now known or later developed.

To create the interactive space, the user can take a photo of a physical space, can take a picture of a printed map (e.g., a hand-drawn picture of a room), or can select an existing image from an image repository. The user can drag icons, from a side panel (e.g., a penalty box) onto a position on the image that represents the space. To drag the icon, the user can place a finger on the touch-screen interface over the icon, and can drag the icon to the desired position over the space's image (or can select and drag the icon using any pointing device, such as a mouse cursor). Once the user has dragged the device icon to the desired position, the user can lift his finger from the touch-screen interface to place the device icon at the desired position (or, if using a mouse or track pad, the user can release the mouse button to place the device icon).

The icons in the side panel represent devices that have not been placed on the space, and the application removes an icon from the side panel once the device icon has been placed onto a position of the space. While moving an icon from the side panel, the application presents an animation within the side-panel that slides other icons (e.g., icons below the removed icon) upward to take up the space left vacant by the placed icon.

In FIG. 1, the interactive map has an icon for a temperature sensor placed next to the window, an icon for a power outlet placed in front of a television, and has an icon for a second power outlet placed next to a lamp. The television and the lamp are powered by different ports of a power strip that the user can control individually via the application. The power strip can monitor an amount of current or power consumed by each of its ports, and can control power to each of its ports. The user can interact with an icon to control a device that is powered by a given port of the power strip. For example, the user can interact with the lamp's device icon to enable or disable power to the power outlet that the lamp is plugged into, which can turn the light on or off (if the lamp's power switch is left on). The user can also interact with the television's device icon to enable or disable power to the power outlet that the television is plugged into.

The user can also remove an icon from the map, for example, by moving the icon from the map to the side panel. The user can select and drag the icon using his finger on the touch-screen interface, or by using a pointing device such as a mouse cursor. When the user drags the icon into the side panel, the application can make room for the device icon by sliding one set of icons upward and/or another set of icons downward to make space for the device icon. In some embodiments, the application makes room for the device icon at a position of the side panel onto which the user has dragged the device icon. In some other embodiments, the application makes room for the device icon in a way that preserves an alphanumeric ordering of the device icons by their device name. For example, when the user drops the device icon on the side panel, the application can animate the side panel's icons sliding to make room for the device icon, and can animate the sliding of the device icon into its target space in the side panel.

FIG. 2 illustrates exemplary operations for controlling devices via speech in accordance with an embodiment. A sensor-interfacing device can be coupled to a microphone for detecting human voices, and for controlling devices wirelessly via speech. When a user speaks commands out loud while in the vicinity of the interfacing device, the sensor-interfacing device analyzes the detected sounds to determine whether the detected sounds include a command. When the sensor-interfacing device detects commands from the user's voice, the interfacing device processes the commands to control a device. For example, a power outlet or power strip interfacing device can provide power to an appliance, such as a lamp (e.g., a lamp coupled to the interfacing device). When the user speaks a command for controlling the lamp, the sensor-interfacing device analyzes the user's spoken words to determine the desired commands for the power outlet or power strip interfacing device. The sensor-interfacing device then communicates these commands to the power outlet or power strip interfacing device, which in turn processes these commands to control power to the lamp, such as by enabling, disabling, or adjusting a power level to the lamp.

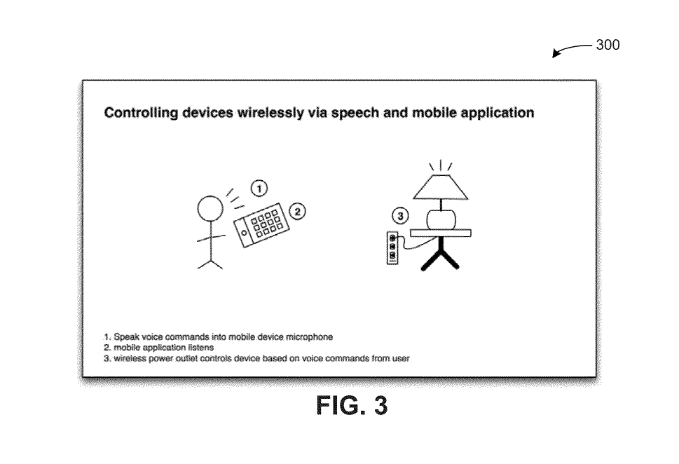

FIG. 3 illustrates exemplary operations for controlling devices via speech and/or a mobile application in accordance with an embodiment. During operation, the user can launch the mobile application on a mobile device, and can speak his commands for controlling a device for the mobile application to hear via a microphone integrated in or coupled to the mobile device. The application analyzes the detected sounds to determine whether the detected sounds include a command, and processes the commands to control a target device. For the example of the power outlet or power strip interfacing device that provides power to a lamp, the user can speak commands for controlling the lamp to the application, and the application analyzes the user's spoken words to determine the desired commands for the interfacing device. The application then communicates these commands to the power outlet or power strip interfacing device, and the interfacing device processes these commands to control power to the lamp.

Various types of interfacing devices, and a software controller for monitoring and controlling a plurality of interfacing devices, are described in a non-provisional application having Ser. No. 13/736,767 and filing date 8 Jan. 2013, entitled “METHOD AND APPARATUS FOR CONFIGURING AND CONTROLLING INTERFACING DEVICES,” which is hereby incorporated by reference in its entirety.

### User Interface

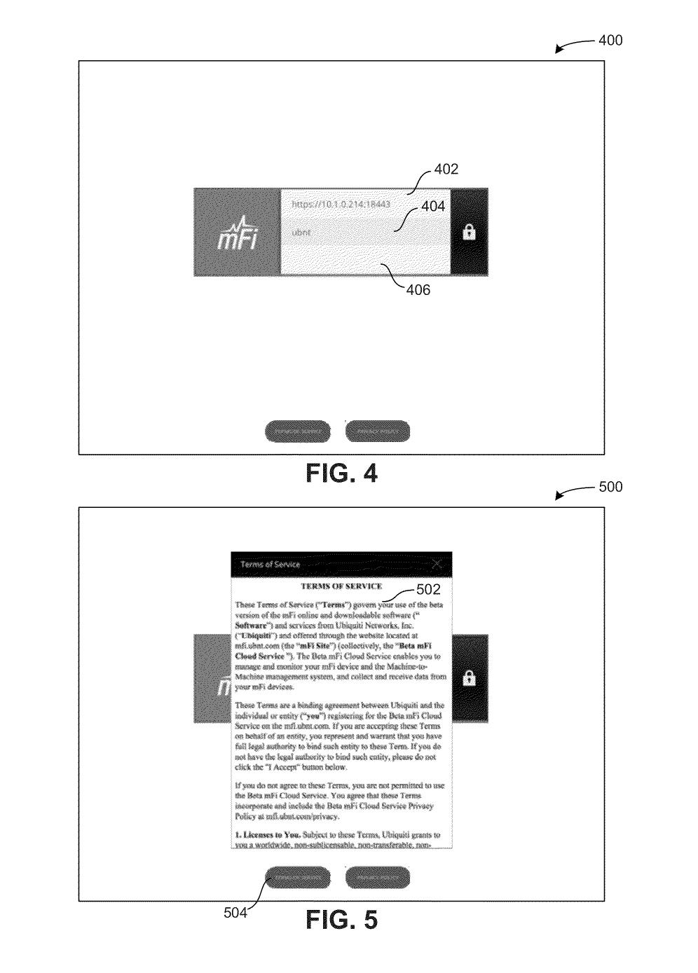

FIG. 4 illustrates a login prompt 400 for accessing a mobile application for controlling an interfacing device in accordance with an embodiment. In login prompt 400, the user can enter a server address into field 402, an account name into field 404, and a password into field 406. The server address can correspond to an Internet service for a software controller that monitors and controls a plurality of sensors across one or more local area networks (LAN), and for one or more consumers. Each consumer can have an account with a unique username and password, such that the Internet service associates the user's personal sensors and devices to his personal account.

The server address can also correspond to a personal server that is operated by the consumer. For example, the server can include a computer within the consumer's local area network that executes the software controller for monitoring and/or controlling a plurality of sensors accessible from the LAN. As another example, the server can include an Internet web server leased by the consumer that executes the software controller for monitoring and/or controlling a plurality of sensors and devices in one or more LANs. The consumer can configure one or more accounts for accessing the software controller to prevent unauthorized users from monitoring, controlling, and/or reconfiguring the sensors and devices.

FIG. 5 illustrates a display 500 for presenting a terms-of-service statement 502 to a user in accordance with an embodiment. The mobile application can present the recent terms of service to the user, for example, when the user is operating the mobile application for the first time, or when the terms of service changes for the mobile application. The mobile application can also present terms of service statement 502 to the user when the user selects a terms of service button 504 from display 500.

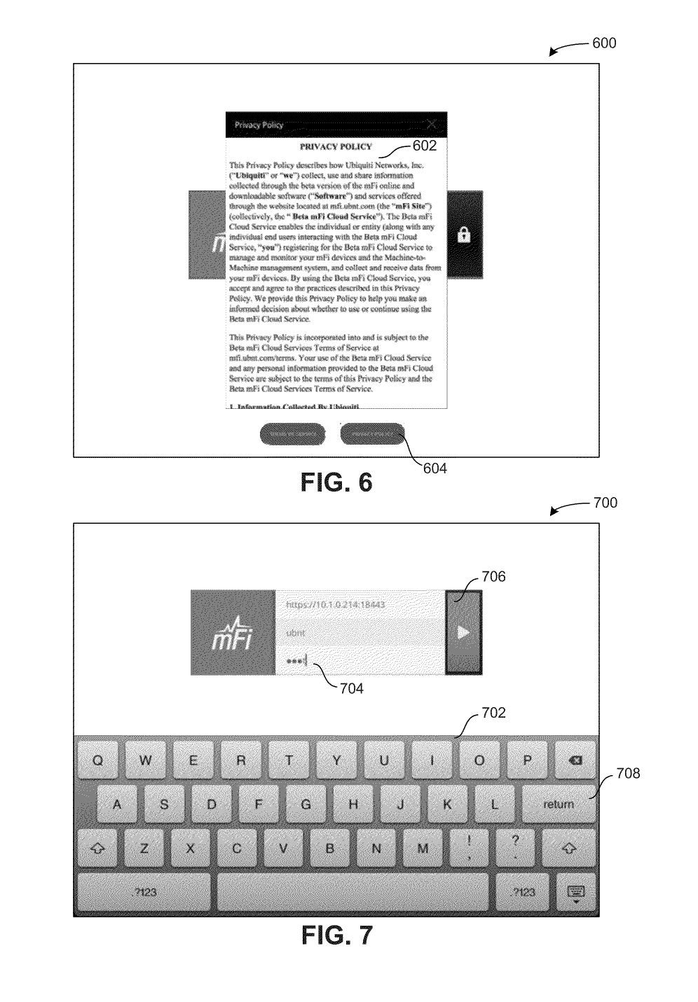

FIG. 6 a display 600 for presenting a privacy policy 602 statement to a user in accordance with an embodiment. The mobile application can present a recent privacy policy to the user, for example, when the user is operating the mobile application for the first time, or when the privacy policy changes for the mobile application. The mobile application can also present privacy policy 602 to the user when the user selects a privacy policy button 604 from display 600.

FIG. 7 a login prompt and an on-screen keyboard for accessing a mobile application for controlling an interfacing device in accordance with an embodiment. The user can use an on-screen keyboard 702 to enter a password 704, and the mobile application can hide the password as the user enters the password. Once the user has typed the password, the user can submit the password by pressing a submit button 706 on display 700 or by pressing a return 708 button on keyboard 702.

In some embodiments, the mobile application provides a user interface that the user may interact with to wirelessly control and synchronize various types of sensors, controller, light dimmers, power switches, or any network-controllable appliance now known or later developed. The sensors can include, for example, a temperature sensor, a motion sensor, a light sensor, a door sensor, a pressure sensor, etc. In some embodiments, a controller can include, for example, a digital thermostat. The user can interact with the mobile application's user interface to view recent or historical sensor data for a device, and/or to wirelessly adjust the device's operating state, for example, by turning the device on or off.

FIG. 8 illustrates an exemplary “Main View” user interface 800 for monitoring and controlling devices in accordance with an embodiment. User inter face 800 presents a main view that the mobile application presents to the user when the user first logs in. User interface 800 includes three top-level sections: a filter panel 802; a device list 804; and a space view 806.

Filter panel 802 includes icons for various device/sensor types. The user can select which device icons to include in device list 804 and space view 806 by selecting the desired device types from filter panel 802, and/or by deselecting the undesired device types from filter panel 802.

Device list 804 includes a listing of devices associated with the space displayed within space view 806. Space view 806 illustrates a visual representation of the space within which the devices are deployed, and illustrates an icon for each device that indicates the device's current sensor state. The mobile application updates the sensor states within device list 804 and space view 806 in real-time, as it receives the data directly from the sensors and/or from a central server running a software controller. For example, when a motion sensor detects a motion, the mobile application can update a corresponding sensor-state icon 808 in device list 804 by adjusting the icon's color to reflect the sensor state. The mobile application can also update a corresponding sensor icon 810 in space view 806 to reflect the sensor state, for example, by adjusting a length of a radial gauge 812 displayed on the icon, and/or by adjusting a color of radial gauge 812 and of a sensor indicator 814.

In some embodiments, the mobile application sets the temperature-indicating color to a shade of red when the sensed temperature is greater than a predetermined number (e.g., 85° F.), and sets the temperature-indicating color to a shade of green otherwise. In some other embodiments, the mobile application selects a color, for the temperature-indicating color, from a color gradient corresponding to a predetermined range of temperatures. The software controller can also adjust a length for radial gauge 812 to indicate the detected temperature with respect to a predetermined range (e.g., a range between −32° F. to 150° F.).

User interface 800 can display a full-screen button 816, and an edit button 818. The user can select the full-screen button 816 to enlarge the space view 806 so that it occupies the full screen of the user's mobile device. The user can select the edit button 818 to add device icons to space view 806, to remove icons from space view 806, and/or to reposition icons within space view 806.

User interface 800 displays a space name 820, for the current space view, at the top of device list 804. In some embodiments, the user can select on space name 820 to select an alternate space to monitor or control.

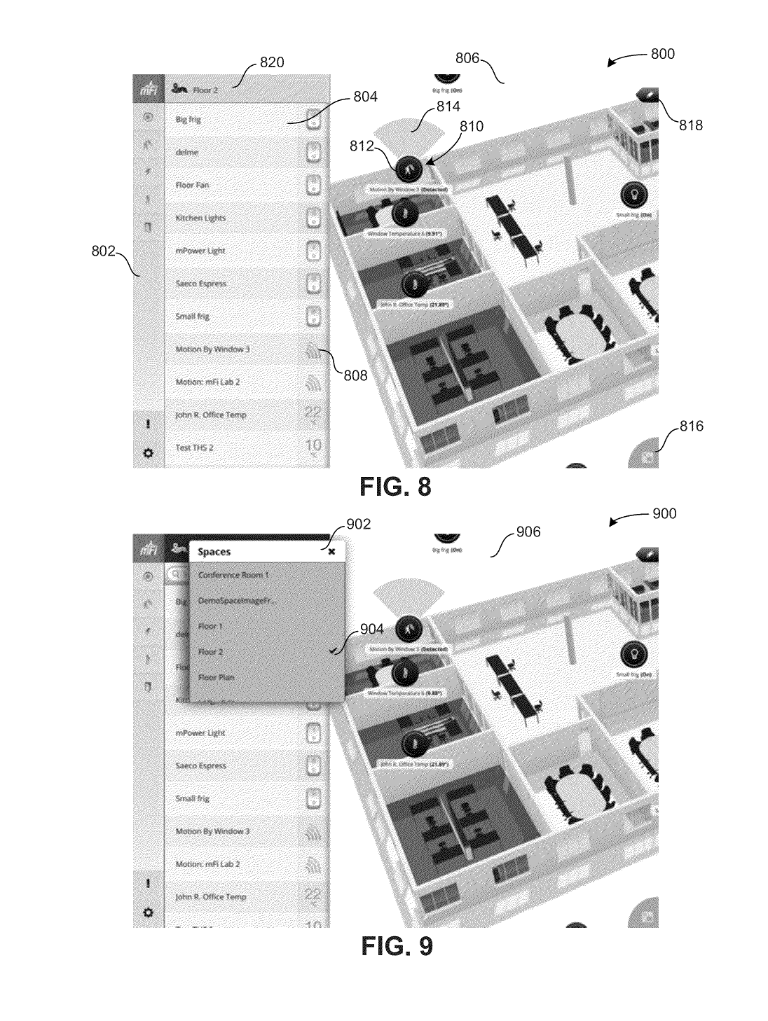

FIG. 9 illustrates an exemplary space-selecting menu 902 for selecting a space to monitor or control in accordance with an embodiment. The mobile application can present space-selecting menu 902 using a pop-up menu overlaid on top of user interface 900. Space-selecting menu 902 can display a checkmark 904 next to the name for the current space view 906. When the user selects a different space view from space-selecting menu 902, user interface 900 can update space view 906 to display the selected space, for example, by sliding in an image representing the selected space from the right side of user interface 900. Alternatively, user interface 900 can update space view 906 by replacing the image for the previous space with the image for the selected space.

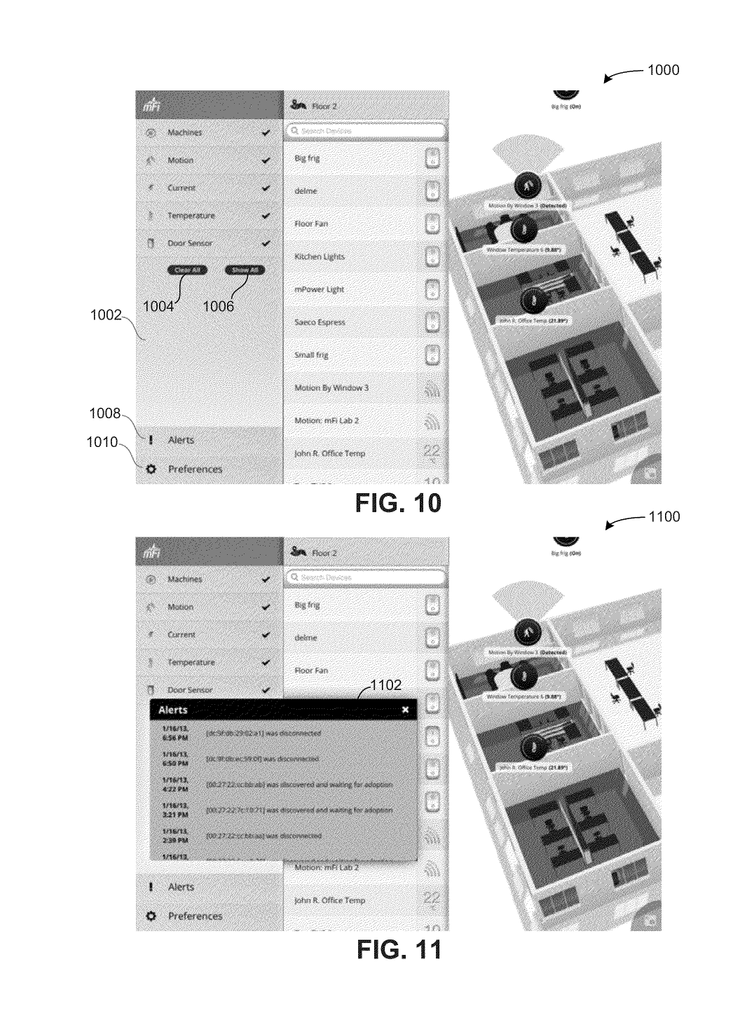

FIG. 10 illustrates an exemplary side panel for configuring the presentation of devices in accordance with an embodiment. The user can expand filter panel 1002, for example, by swiping his finger from the left edge of user interface 1000 toward the right. Expanded filter panel 1002 displays a name next to the individual sensor types, and displays a checkmark next to the sensor types that are currently being displayed. Expanded filter panel 1002 can also display a “clear all” button 1004 for deselecting all sensor types, and a “show all” button 1006 for selecting all sensor types.

The sensor types can include a “Machines” type, a “Motion” type, a “Current” type, a “Temperature” type, and a “Door Sensor” type. The “Machines” type is associated with power outlets that can control power to a device (e.g., a “machine”). The “Motion” type is associated with motion sensors, such as motion sensor coupled to an interfacing device. The “Current” type is associated with current sensors, such as a current sensor coupled to a sensor-interfacing device, or a current sensor embedded within a power outlet or power strip interfacing device, or within a light controller (e.g., a light switch or light-dimming device). The “Temperature” type is associated with temperature sensors, such as a temperature sensor coupled to a sensor-interfacing device, or embedded within a digital thermostat. The “Door Sensor” type is associated with a door sensor, which can be coupled to a sensor-interfacing device.

Expanded filter panel 1002 also displays an “Alerts” label next to alerts button 1008, and displays a “Preferences” label next to preferences button 1010.

FIG. 11 illustrates an exemplary alerts menu 1102 for viewing recent alerts in accordance with an embodiment. The mobile application can present alerts menu 1102 using a pop-up menu overlaid on top of user interface 1100. Alerts menu 1102 can include a determinable number of alerts obtained from the software controller. For example, alerts menu 1102 can include alerts generated during a determinable time period (e.g., during the last 24 hours), can be restricted to a maximum number of alerts (e.g., a maximum of 20 alerts), and/or can filter out alerts that the mobile application has already presented to the user. In some embodiments, the mobile application can also cause it's application icon (not shown) to include a badge indicating a number of alerts that the user has not viewed.

The individual alert entries can indicate a timestamp for when the alert was generated, and a description for the alert. For example, if an alert indicates a status for a device, the alert's description can include a device identifier for the device (e.g., a MAC address, or a logical identifier for the device), and can include a message indicating the updated state for the device.

In some embodiments, the user can use the software controller to configure new alerts. For example, the user can use the software controller to create a rule whose action description causes the software controller to generate an alert that is to be displayed by the mobile application. The rule can also include one or more conditions that indicate when the software controller is to generate the alert.

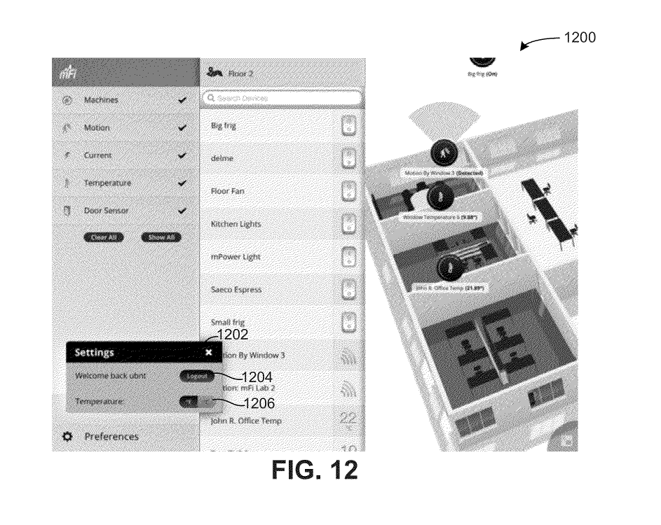

FIG. 12 illustrates an exemplary settings menu 1202 for configuring settings in accordance with an embodiment. The software mobile application can present settings menu 1202 using a pop-up menu overlaid on top of user interface 1200. Settings menu 1202 can include at least a logout button 1204 and a temperature setting 1206. The user can select logout button 1204 to log out from the mobile application. The user can also toggle temperature setting 1206 to configure the mobile application to display temperatures using the Fahrenheit temperature scale, or the Celsius temperature scale. In some embodiments, the settings configured within settings menu 1202 are stored locally by the mobile application for the current user (and/or for other users of the local mobile application as well), without communicating the settings to the software controller.

In some other embodiments, the settings configured within settings menu 1202 are communicated to and stored by the software controller, for example, by associating these settings with the current user or attributing these settings as general settings for any user. This facilitates the software controller and any application (e.g., the mobile application) to utilize these settings for the current user and/or for any other user, regardless of which computing device is being used to monitor the sensors and devices.

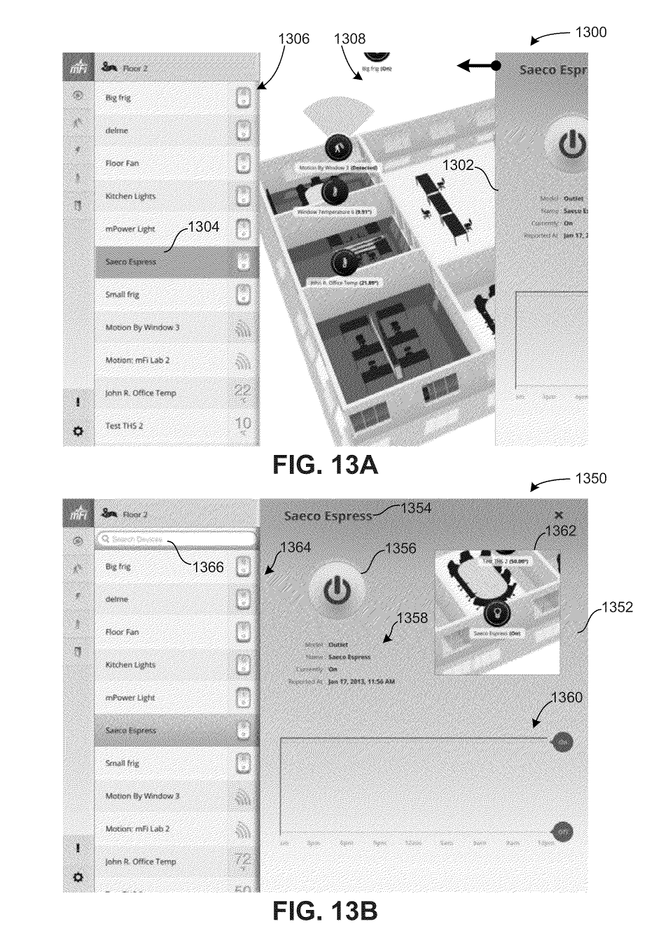

FIG. 13A illustrates an exemplary animation for displaying a sensor-detail view 1302 in accordance with an embodiment. When the user selects a device 1304 from device list 1306 or from space view 1308, the mobile application presents an animation that slides sensor-detail view 1302 into view, from the right edge of user interface 1300, so that sensor-detail view 1302 covers space view 1308.

FIG. 13B illustrates an exemplary sensor-detail view 1352 for a power outlet in accordance with an embodiment. Sensor-detail view 1352 can include a name 1354 for a device, as well as a device state 1356 for the device. Device state 1356 illustrates a power symbol using a first color (e.g., light blue) when a power output is enabled for the corresponding outlet, and illustrates the power symbol using a second color (e.g., grey) when the power output is disabled for the outlet.

Sensor-detail view 1352 can also include a device snapshot 1358, which can indicate a type or model number for the device (e.g., for an a power outlet or power strip interfacing device that includes the outlet). Sensor snapshot 1358 can also indicate the name for the device, a current (or recent) state for the device (e.g., “on” or “off”), and a latest timestamp at which the device last reported its state.

Sensor-detail view 1352 can also illustrate a real-time graph 1360 that displays device states over a determinable time range, for example, using a sliding window that covers the last 24 hours. As the mobile application receives real-time data for the device, the application can update real-time graph 1360 to include the recent measurement. The mobile application can also display a current state, for other sensors or devices within the current sensor “space,” within sensor list 1364 next these sensors' or devices' names.

In some embodiments, a power outlet can include a sensor for monitoring an electrical current, voltage, and/or power measurement. Hence, the mobile application can update sensor-detail view 1352 (e.g., in device state 1356, device snapshot 1358, and/or real-time graph 1360) to display a range of values that can correspond to the power outlet's electrical-current output, voltage output, or power output.

In some embodiments, sensor-detail view 1352 can include a device-placement view 1362 that illustrates the device's position within a given space. For example, when the mobile application reveals sensor-detail view 1350, the application can display a portion of the space view (e.g., space view 1308 of FIG. 13A) so that the device is centered within device-placement view 1362.

The user can select another sensor from sensor list 1364 while user interface 1350 is presenting sensor-detail view 1352, and in response to the selection, the mobile application updates sensor-detail view 1352 to display data associated with this selected sensor. In some embodiments, while the mobile application is updating sensor-detail view 1352, the application can display the selected sensor's icon by panning the image for the sensor “space” to reveal and center the selected sensor's icon within device-placement view 1362.

If the user does not want to scroll through sensor list 1364 to manually search for a desired sensor, the user can pull down on sensor list 1364 to reveal a search field 1366, which the user can use to enter a name for a desired sensor. As the user types characters within search field 1366, the mobile application uses the typed letters to identify a filtered set of sensors or devices whose names match the typed characters, and updates sensor list 1364 in real-time to include the filtered set of sensors or devices.

In some embodiments, real-time graph 1360 provides additional user-interface controls that facilitate navigating through historical sensor data. For example, the user can interact with real-time graph 1360 to modify a time range for graph 1360. The user can finger-swipe right to adjust the time window for graph 1360 toward previous historical sensor measurements, or the user can finger-swipe left to adjust the time window for graph 1360 toward more recent sensor measurements. The user can also adjust a length for the time window, for example, by pinching two fingers closer together (e.g., to increase the size of the time interval) or by pinching two fingers further apart (e.g., to decrease the size of the time interval).

The user can also touch on a portion of real-time graph 1360 to select a time instance, and the system can present a detailed snapshot for the selected time instance. In some embodiments, the system updates sensor snapshot 1358 and/or device-placement view 1362 to include historical information for the selected time instance. The system can also present information from other sensors corresponding to the selected time instance, for example, within device list 1306, and/or within a pop-up window (not shown).

If the user wants to reveal the space view (e.g., space view 1308 of FIG. 13A), the user can select a close button 1368 to remove sensor-detail view 1362. In some embodiments, the mobile application reveals the space view by sliding sensor-detail view 1362 toward the right edge of user interface 1500, and revealing the space view underneath.

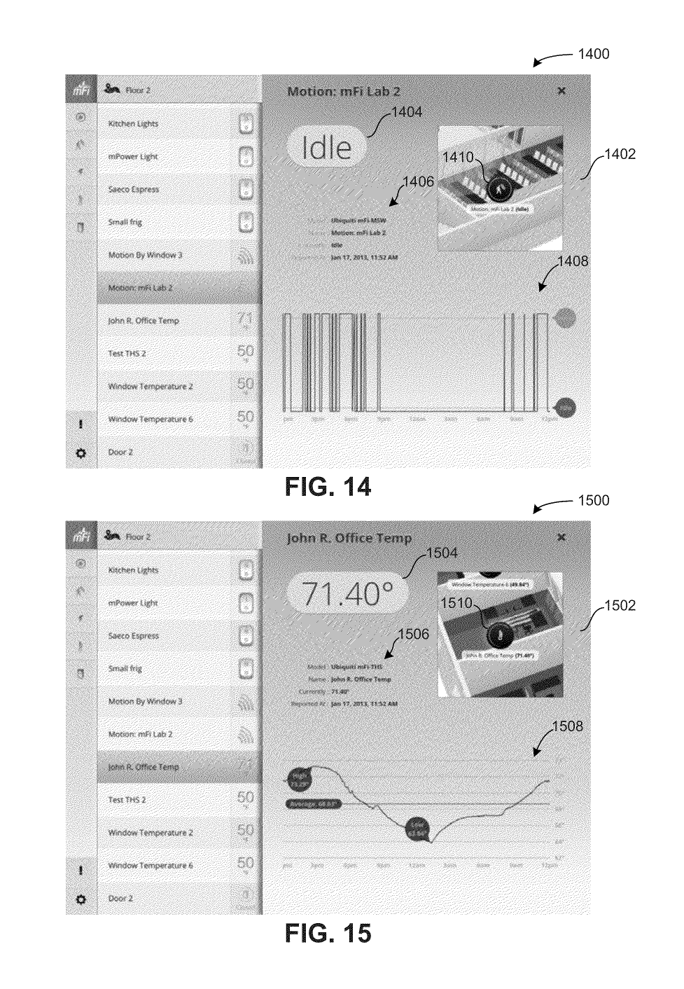

FIG. 14 illustrates an exemplary sensor-detail view 1402 for a motion sensor in accordance with an embodiment. In some embodiments, the motion sensor's state can include a binary value, such as to indicate whether motion within a space is “idle” (e.g., no motion is detected), or whether a motion within the space is “detected.” The mobile application can update sensor state 1404, a sensor snapshot 1406, a real-time-graph 1408, and a device-placement view 1410, in real-time, to present the motion sensor's most recent state.

As is described with respect to FIG. 13, the user can touch on a portion of real-time graph 1408 to select a time instance, and the mobile application can present a detailed sensor snapshot for the selected time instance. For example, the system can update sensor snapshot 1406 and/or device-placement view 1410 to include historical information for the selected time instance. The system can also present information from other sensors corresponding to the selected time instance, for example, within the sensor list, and/or within a pop-up window (not shown).

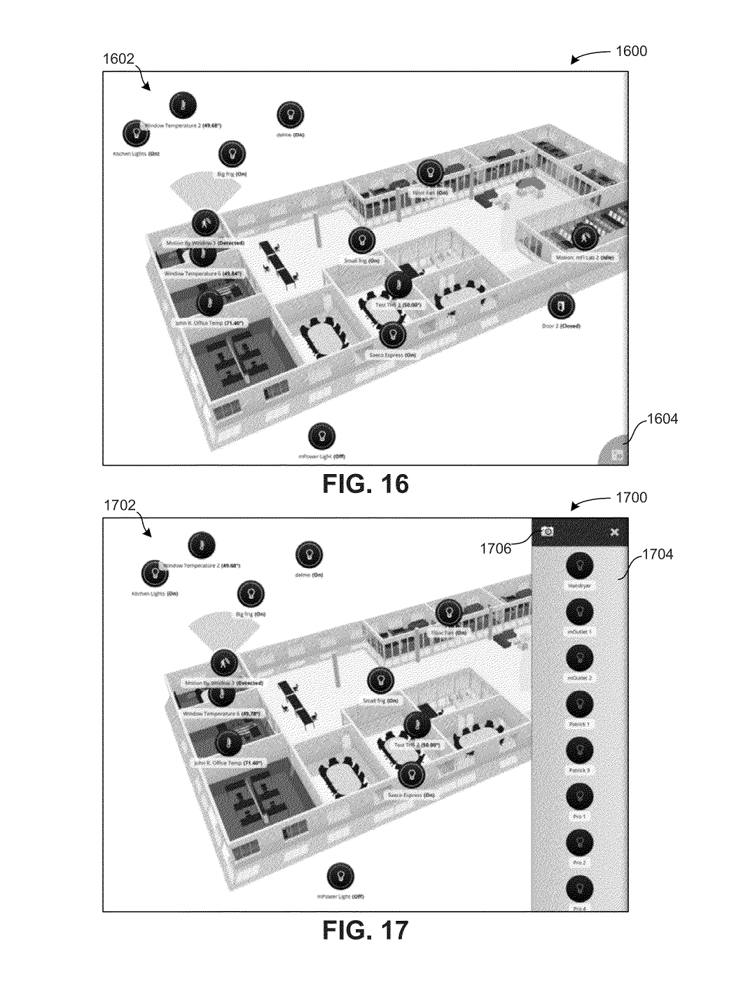

In some embodiments, if the image for the “space” view is a real-time image from a camera sensor (e.g., for space-view 806 of FIG. 8), the mobile application can update device-placement view 1410 to show a camera image or video of the sensor's “space” for the selected time instance. The user can touch on device-placement view 1410 to view the image for the “space” in full-screen mode (e.g., full-screen space view 1602 of FIG. 16), which facilitates the user zooming in and/or out of the “space,” and facilitates scrolling through the space. Hence, if the motion sensor is used to realize a security system, a security agent can navigate back in time to view a camera image or video that reveals an object which caused the motion sensor to detect motion, and to explore the camera image or video in detail.

FIG. 15 illustrates an exemplary sensor-detail view 1502 for a temperature sensor in accordance with an embodiment. In some embodiments, the temperature sensor's state can include a numeric value within a predetermined temperature range (e.g., a temperature between −32° F. and 150° F.). The mobile application can update sensor state 1504, a sensor snapshot 1506, a real-time-graph 1508, and a sensor icon 1510, in real-time, to present the temperature sensor's most recent measurement.

FIG. 16 illustrates an exemplary full-screen space view 1602 for a sensor deployment space in accordance with an embodiment. The mobile application can display full-screen space view 1602, so that it covers user interface 1600, in response to the user selecting a full-screen button (e.g., full-screen button 816 of FIG. 8). To enter the full-screen mode, the mobile application can slide space-view 1602 toward the left edge of user interface 1602 so that it covers over the filter panel and the device list (e.g., filter panel 802 and device list 804 of FIG. 8). While in full-screen mode, the user can use the touch-screen interface to scroll through the “space,” for example, by placing his finger on the touch-screen surface and sliding his finger across the touch-screen surface. The user can also zoom in or zoom out of the “space,” for example, by placing two fingers (e.g., a thumb and an index finger), and pinching the fingers closer together or further apart to zoom in or to zoom out, respectively.

The user can exit full-screen mode by selecting button 1604, which causes the mobile application to slide space-view 1602 toward the right edge of user interface 1600 to reveal the filter panel and the device list.

In some embodiments, the mobile application can provide a user with an augmented-reality space, which adjusts the devices that are displayed within a space-view screen based on an orientation of the user's device. For example, the mobile application can use a live video feed as the image source for space view 806 of FIG. 8, or for full-screen space view 1602 of FIG. 16. The mobile application can receive the live video feed from the portable device's camera (e.g., a smartphone, tablet computer, etc.), or from a peripheral camera (e.g., a camera mounted on the user's eyeglasses).

While presenting the augmented-reality space to the user, the mobile application can monitor a location and orientation for the user to determine which device icons to present in the augmented-reality space, and where to present these device icons. The user's portable device can determine the user's location by wireless triangulation (e.g., using cellular towers and/or WiFi hotspots), by using a global positioning system (GPS) sensor, and/or by using any positioning technology now known or later developed. The mobile application can determine the user's orientation based on compass measurement from a digital compass on the user's portable device or eyeglasses. The mobile application can then select device icons for devices that are determined to have a location within a predetermined distance in front of the user, as determined based on the user's location and orientation.

In some embodiments, the mobile application can use additional information known about the selected device icons to determine where on the live video feed to display the device icons. For example, the selected device icons can be associated with a vertical position. The mobile application can use a device icon's known physical location (GPS coordinates) and its vertical position to determine a position of the augmented-reality space within which to display the device icon. The mobile application can also use a device icon's know device type to determine a position of the live video feed for the device icon. For example, if the device icon is for a light switch, the mobile application can analyze the live video feed to determine an image position for a light switch, and uses this image position to display the device icon that corresponds with the light switch. Hence, by locking a device icon to a feature of the live video feed, the mobile application can display the device icon in a way that indicates a physical device or sensor associated with the device icon, and in a way that prevents the device icon from appearing to float as the user pans, tilts, or zooms the camera.

FIG. 17 illustrates an exemplary user interface 1700 for placing, moving, and removing sensor icons over a sensor deployment space in accordance with an embodiment. The user can select camera button 1706 to set a background image for interactive space 1702. For example, after selecting camera button 1706, the user can take a photo of a physical space, can take a picture of a printed map (e.g., a hand-drawn picture of a room), or can select an existing image from an image repository. For example, the user can take a picture of a room in a house, or of an entertainment center in the living room.

The user can populate the interactive space with icons for devices or sensors which have been provisioned with the software controller. The user can drag an icon, from a side panel 1704, onto a position on interactive space 1702. To drag the icon, the user can place a finger on the touch-screen interface over the icon in side panel 1704, and can drag the icon to the desired position over interactive space 1702. Once the user has dragged the device icon to the desired position, the user can lift his finger from the touch-screen interface to place the device icon at the desired position. The user can also place the icon onto interactive space 1702 using any other pointing device now known or later developed, such as a mouse or touchpad, by selecting and dragging the icon to the desired position using the pointing device.

The icons in side panel 1704 represent devices that have not been placed on interactive space 1702, and the mobile application removes an icon from side panel 1704 once the device icon has been placed onto a position of interactive space 1702. While moving an icon from side panel 1704, the mobile application presents an animation within side panel 1704 that slides other icons (e.g., icons below the removed icon) upward to take up the space left vacant by the placed icon.

The user can also remove an icon from interactive space 1702, for example, by moving the icon from interactive space 1702 to side panel 1704. The user can select and drag the icon using his finger on the touch-screen interface, or by using a pointing device such as a mouse cursor. When the user drags the icon into side panel 1704, the mobile application can make room for the device icon by sliding one set of icons upward and/or another set of icons downward to make space for the device icon. In some embodiments, the mobile application makes room for the device icon at a position of side panel 1704 onto which the user has dragged the device icon. In some other embodiments, the application makes room for the device icon in a way that preserves an alphanumeric ordering of the device icons by their device name. For example, when the user drops the device icon on side panel 1704, the mobile application can animate sliding icons in side panel 1704 to make room for the incoming device icon, and can animate the sliding of the device icon into its target space in side panel 1704.

In some embodiments, when the user makes a change to the configuration of a sensor, or to the configuration of an interactive space, the mobile application can communicate the updated configurations to the software controller. The software controller, which can run on a computing device within a LAN, or on a server computer or a computer cluster, can store the updated configuration for use by the mobile application running on one or more mobile computing devices. Hence, when a user updates a configuration for a sensor or for an interactive space a local mobile computing device, other users monitoring or controlling sensors on other computing devices can see the updated configurations in near real-time.

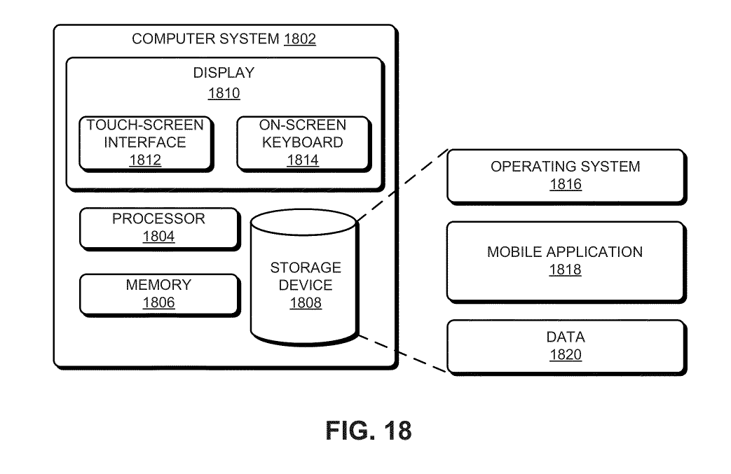

FIG. 18 illustrates an exemplary computer system 1802 that facilitates monitoring and controlling sensors and devices in accordance with an embodiment. Computer system 1802 includes a processor 1804, a memory 1806, a storage device 1808, and a display 1810. Memory 1806 can include a volatile memory (e.g., RAM) that serves as a managed memory, and can be used to store one or more memory pools. Display 1810 can include a touch-screen interface 1812, and can be used to display an on-screen keyboard 1214. Storage device 1808 can store operating system 1816, a mobile application 1818 for monitoring and controlling sensors and devices, and data 1826.

Data 1826 can include any data that is required as input or that is generated as output by the methods and/or processes described in this disclosure. Specifically, data 1826 can store at least network address information for a plurality of sensors and devices, as well as username or any other type of credentials for interfacing with the sensors and devices. Data 1826 can also include user preferences for mobile application 1818, historical sensor data from the sensors and devices, and/or any other configurations or data used by mobile application 1818 to allow the user to monitor and/or control the sensors and devices.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for monitoring sensor data, the method comprising:
presenting a user interface (UI) comprising a first UI element that includes a listing of one or more electronic devices;
receiving a selection for a first device listed in the first UI element; and
responsive to receiving the selection for the first device, presenting a second UI element that indicates at least a sensor measurement for the first device and a location of the first device.

2. The method of claim 1, further comprising:
updating the first UI element, in real-time, to include recent information for sensors listed in the first UI element.

3. The method of claim 1, wherein presenting the second UI element involves presenting an animation that slides the second UI element from a right edge of the user interface.

4. The method of claim 1, wherein the second UI element also includes one or more of:
a name for a corresponding device;
a status icon that illustrates a state of the device;
a power button for enabling or disabling the device;
a sensor snapshot that indicates information received from the device;
a visual representation of a space at which the device is deployed; and
a graph visualization that illustrates device states for a determinable time range.

5. The method of claim 1, further comprising:
receiving a selection for a second device listed in the first UI element, while presenting the second UI element; and
updating the second UI element to include information associated with the second device, without removing the second UI element.

6. The method of claim 1, further comprising presenting a space-visualizing UI element that illustrates a visual representation for a physical space, and illustrates device icons for one or more devices deployed in the physical space.

7. The method of claim 6, wherein the visual representation for the physical space includes a live image freed from a pan-tilt camera, and wherein the method further comprises:
determining that the image from the pan-tilt camera has shifted; and
adjusting a position for a device icon on the space-visualizing UI element to account for the image shift.

8. The method of claim 6, wherein the space-visualizing UI element includes an augmented-reality user interface, wherein the visual representation for the physical space includes a live image feed from a portable computing device, and wherein the method further comprises:
determining a position and orientation for the portable computing device;
determining one or more devices located in front of an image sensor of the portable computing device; and
overlaying device icons for the one or more devices over the visual representation.

9. The method of claim 6, wherein a respective device icon includes illustrations for one or more of:
a name for the corresponding device;
a sensor measurement;
a gauge to illustrate a magnitude of the sensor measurement; and
a sensor indicator to illustrate a sensor type.

10. The method of claim 6, wherein the space-visualizing UI element includes a screen-maximize button, and wherein the method further comprises:
determining that a user has selected the screen-maximize button; and
expanding the space-visualizing UI element to occupy the user interface.

11. The method of claim 10, wherein expanding involves sliding the space-visualizing UI element from a right side of the user interface.

12. The method of claim 10, wherein the expanded space-visualizing UI element also includes a camera icon for capturing an image to use as the visual representation of the physical space, and wherein the method further comprises:
responsive to the user selecting the camera icon, providing the user with a camera user interface for capturing a picture using an image sensor; and
responsive to the user capturing an image, using the captured image as the visual representation of the physical space.

13. The method of claim 10, wherein the expanded space-visualizing UI element also includes a side-panel user interface comprising a set of device icons provisioned devices, and wherein the method further comprises:
allowing a user to drag a device icon for a provisioned device to a desired position of the visual representation; and
communicating the placement position of the provisioned device to a central controller that manages the provisioned devices.

14. The method of claim 10, wherein the expanded space-visualizing UI element includes a screen-minimize button, and wherein the method further comprises:
determining that a user has selected the screen-minimize button; and
minimizing the space-visualizing UI element to reveal the first UI element.

15. The method of claim 14, wherein minimizing involves sliding the space-visualizing UI element toward a right side of the user interface.

16. The method of claim 6, wherein presenting the second UI element involves overlaying the second UI element over the third UI element.

17. The method of claim 16, wherein updating the second UI element involves scrolling a space-view image, which presents a visual representation of a space, to reveal a location associated with the second device.

18. The method of claim 1, wherein the first UI element further includes a space-indicating UI element that includes a label for a physical space.

19. The method of claim 18, further comprising:
determining that a user has selected the space-indicating UI element; and
displaying a space-listing menu that includes a list of physical spaces associated with one or more deployed devices.

20. The method of claim 19, further comprising:
determining that a user has selected a physical space from the space-listing menu;
updating the first UI element to include a listing of devices associated with the selected physical space; and
updating a space-visualizing UI element to illustrate a visual representation for the selected physical space, and to illustrate device icons for the devices associated with the physical space.

21. A non-transitory computer-readable storage medium storing instructions that when executed by a computer cause the computer to perform a method for monitoring sensor data, the method comprising:
presenting a user interface (UI) comprising a first UI element that includes a listing of one or more electronic devices;
receiving a selection for a first device listed in the first UI element; and
responsive to receiving the selection for the first device, presenting a second UI element that indicates at least a sensor measurement for the first device and a location of the first device.

22. The storage medium of claim 21, wherein the method further comprises:
updating the first UI element, in real-time, to include recent information for sensors listed in the first UI element.

23. The storage medium of claim 21, wherein presenting the second UI element involves presenting an animation that slides the second UI element from a right edge of the user interface.

24. The storage medium of claim 21, wherein the second UI element also includes one or more of:
a name for a corresponding device;
a status icon that illustrates a state of the device;
a power button for enabling or disabling the device;
a sensor snapshot that indicates information received from the device;
a visual representation of a space at which the device is deployed; and
a graph visualization that illustrates device states for a determinable time range.

25. The storage medium of claim 21, wherein the method further comprises:
receiving a selection for a second device listed in the first UI element, while presenting the second UI element; and
updating the second UI element to include information associated with the second device, without removing the second UI element.

26. The storage medium of claim 21, wherein the method further comprises presenting a space-visualizing UI element that illustrates a visual representation for a physical space, and illustrates device icons for one or more devices deployed in the physical space.

27. The storage medium of claim 26, wherein the visual representation for the physical space includes a live image freed from a pan-tilt camera, and wherein the method further comprises:
determining that the image from the pan-tilt camera has shifted; and
adjusting a position for a device icon on the space-visualizing UI element to account for the image shift.

28. The storage medium of claim 26, wherein the space-visualizing UI element includes an augmented-reality user interface, wherein the visual representation for the physical space includes a live image feed from a portable computing device, and wherein the method further comprises:
determining a position and orientation for the portable computing device;
determining one or more devices located in front of an image sensor of the portable computing device; and
overlaying device icons for the one or more devices over the visual representation.

29. The storage medium of claim 26, wherein a respective device icon includes illustrations for one or more of:
a name for the corresponding device;
a sensor measurement;
a gauge to illustrate a magnitude of the sensor measurement; and
a sensor indicator to illustrate a sensor type.

30. The storage medium of claim 26, wherein the space-visualizing UI element includes a screen-maximize button, and wherein the method further comprises:
determining that a user has selected the screen-maximize button; and
expanding the space-visualizing UI element to occupy the user interface.

31. The storage medium of claim 30, wherein expanding involves sliding the space-visualizing UI element from a right side of the user interface.

32. The storage medium of claim 30, wherein the expanded space-visualizing UI element also includes a camera icon for capturing an image to use as the visual representation of the physical space, and wherein the method further comprises:
responsive to the user selecting the camera icon, providing the user with a camera user interface for capturing a picture using an image sensor; and
responsive to the user capturing an image, using the captured image as the visual representation of the physical space.

33. The storage medium of claim 30, wherein the expanded space-visualizing UI element also includes a side-panel user interface comprising a set of device icons provisioned devices, and wherein the method further comprises:
allowing a user to drag a device icon for a provisioned device to a desired position of the visual representation; and
communicating the placement position of the provisioned device to a central controller that manages the provisioned devices.

34. The storage medium of claim 30, wherein the expanded space-visualizing UI element includes a screen-minimize button, and wherein the method further comprises:
determining that a user has selected the screen-minimize button; and
minimizing the space-visualizing UI element to reveal the first UI element.

35. The storage medium of claim 34, wherein minimizing involves sliding the space-visualizing UI element toward a right side of the user interface.

36. The storage medium of claim 26, wherein presenting the second UI element involves overlaying the second UI element over the third UI element.

37. The storage medium of claim 36, wherein updating the second UI element involves scrolling a space-view image, which presents a visual representation of a space, to reveal a location associated with the second device.

38. The storage medium of claim 21, wherein the first UI element further includes a space-indicating UI element that includes a label for a physical space.

39. The storage medium of claim 38, wherein the method further comprises:
determining that a user has selected the space-indicating UI element; and
displaying a space-listing menu that includes a list of physical spaces associated with one or more deployed devices.

40. The storage medium of claim 39, wherein the method further comprises:
determining that a user has selected a physical space from the space-listing menu;
updating the first UI element to include a listing of devices associated with the selected physical space; and
updating a space-visualizing UI element to illustrate a visual representation for the selected physical space, and to illustrate device icons for the devices associated with the physical space.

41. An apparatus for monitoring sensor data, the method comprising:
a display device;
a processor;
a memory;
a presenting module to present, on the display device, a user interface (UI) comprising a first UI element that includes a listing of one or more electronic devices;
an input module to receive a user input that includes a selection for a first device listed in the first UI element; and
wherein responsive to receiving the selection for the first device, the presenting module is further configured to present a second UI element that indicates at least a sensor measurement for the first device and a location of the first device.

42. The apparatus of claim 41, wherein the presenting module is further configured to:
update the first UI element, in real-time, to include recent information for sensors listed in the first UI element.

43. The apparatus of claim 41, wherein presenting the second UI element involves presenting an animation that slides the second UI element from a right edge of the user interface.

44. The apparatus of claim 41, wherein the second UI element also includes one or more of:
a name for a corresponding device;
a status icon that illustrates a state of the device;
a power button for enabling or disabling the device;
a sensor snapshot that indicates information received from the device;
a visual representation of a space at which the device is deployed; and
a graph visualization that illustrates device states for a determinable time range.

45. The apparatus of claim 41, wherein the input module is further configured to receive a selection for a second device listed in the first UI element, while presenting the second UI element; and
wherein the presenting module is further configured to update the second UI element to include information associated with the second device, without removing the second UI element.

46. The apparatus of claim 41, wherein the presenting module is further configured to present a space-visualizing UI element that illustrates a visual representation for a physical space, and illustrates device icons for one or more devices deployed in the physical space.

47. The apparatus of claim 46, wherein the visual representation for the physical space includes a live image freed from a pan-tilt camera, and wherein the apparatus further comprises a space-updating module to:
determine that the image from the pan-tilt camera has shifted; and
adjust a position for a device icon on the space-visualizing UI element to account for the image shift.

48. The apparatus of claim 46, wherein the space-visualizing UI element includes an augmented-reality user interface, wherein the visual representation for the physical space includes a live image feed from a portable computing device, and wherein the apparatus further comprises a space-updating module to:
determine a position and orientation for the portable computing device;
determine one or more devices located in front of an image sensor of the portable computing device; and
overlay device icons for the one or more devices over the visual representation.

49. The apparatus of claim 46, wherein a respective device icon includes illustrations for one or more of:
a name for the corresponding device;
a sensor measurement;
a gauge to illustrate a magnitude of the sensor measurement; and
a sensor indicator to illustrate a sensor type.

50. The apparatus of claim 46, wherein the space-visualizing UI element includes a screen-maximize button;
wherein the input module is further configured to determine when a user has selected the screen-maximize button; and
wherein the presenting module is further configured to expand the space-visualizing UI element to occupy the user interface.

51. The apparatus of claim 50, wherein expanding involves sliding the space-visualizing UI element from a right side of the user interface.

52. The apparatus of claim 50, wherein the expanded space-visualizing UI element also includes a camera icon for capturing an image to use as the visual representation of the physical space, and wherein the presenting module is further configured to:
provide the user with a camera user interface for capturing a picture using an image sensor responsive to the user selecting the camera icon; and
use the captured image as the visual representation of the physical space responsive to the user capturing an image.

53. The apparatus of claim 50, wherein the expanded space-visualizing UI element also includes a side-panel user interface comprising a set of device icons provisioned devices;
wherein the input module is further configured to receive a user input that drags a device icon for a provisioned device to a desired position of the visual representation; and
wherein the apparatus further comprises a communication module to communicate the placement position of the provisioned device to a central controller that manages the provisioned devices.

54. The apparatus of claim 50, wherein the expanded space-visualizing UI element includes a screen-minimize button;
wherein the input module is further configured to receive a user input that selects the screen-minimize button; and
wherein the presenting module is further configured to minimize the space-visualizing UI element to reveal the first UI element.

55. The apparatus of claim 54, wherein minimizing involves sliding the space-visualizing UI element toward a right side of the user interface.

56. The apparatus of claim 46, wherein presenting the second UI element involves overlaying the second UI element over the third UI element.

57. The apparatus of claim 56, wherein updating the second UI element involves scrolling a space-view image, which presents a visual representation of a space, to reveal a location associated with the second device.

58. The apparatus of claim 41, wherein the first UI element further includes a space-indicating UI element that includes a label for a physical space.

59. The apparatus of claim 58, wherein the input module is further configured to receive a user input that selects the space-indicating UI element; and
wherein the presenting module is further configured to display a space-listing menu that includes a list of physical spaces associated with one or more deployed devices.

60. The apparatus of claim 59, wherein the input module is further configured to receive a user input that selects a physical space from the space-listing menu; and
wherein the presenting module is further configured to:
update the first UI element to include a listing of devices associated with the selected physical space; and
update a space-visualizing UI element to illustrate a visual representation for the selected physical space, and to illustrate device icons for the devices associated with the physical space.
